(19) United States
(12) Patent Application Publication
(10) Pub. No.: US 2010/0116638 A1
(43) Pub. Date: May 13, 2010

(54) SOCKET ASSEMBLY

(76) Inventors: Glenn J. Luzzi, Mt. Bethel, PA (US); Joseph Bier, Warren, NJ (US)

Correspondence Address: STROOCK & STROOCK & LAVAN LLP, 180 MAIDEN LANE, NEW YORK, NY, 10038, US

(21) Appl. No.: 12/617,414

(22) Filed: Nov. 12, 2009

Related U.S. Application Data
(60) Provisional application No. 61/113,832, filed on Nov. 12, 2008.

(51) Int. Cl. H01H 1/58; H01R 13/44; H01R 11/00

(52) U.S. Cl. 200/51 R; 439/136; 439/502

(57) ABSTRACT

A socket assembly for use with a cable joint, the socket assembly including a shut off device for disabling the power to the socket after a predetermined period of time, the socket having a body having an interface for connecting to an electric device, a power lead connected to the interface at one end and constructed and arranged to be connected to the cable joint at the other end, a ground lead connected to the interface, and a neutral lead connected to the interface.

### CLAIM OF PRIORITY

This application claims the benefit of priority under 35 U.S.C. §119(e) to U.S. Provisional Application No. 61/113,832, filed Nov. 12, 2008, titled Socket Assembly, which application is also hereby incorporated by reference in its entirety.

### BACKGROUND OF THE INVENTION

Various activities can be performed underground that require power. For example, a technician may enter the underground location at which work must be done via a manhole or other opening. The technician often requires power for the electric tools that are required to perform the work, such as a lamp to illuminate the area, an electric drill, a torch, etc.

In accordance with common practice, the technician often takes a receptacle, most likely with three #12 wires (hot, neutral and ground). The technician ties the ground and neutral wires together and attaches them to the system ground. To access power for their electric tools or other uses, the technician often drives a nail into a powered line, such as a 120v line and clips the hot wire to it. The hot wire thus becomes powered and an electric tool can be connected to the hot wire to provide power to the electric tool. Before the technician leaves the structure having the hot wire connected thereto, the technician may forget to remove the nail or he may remove the nail from the powered line and the receptacle, and seal and tape up the hot wire where the nail was removed. Such a practice can be dangerous to the technician as well as to persons subsequently coming into the location. For example, stray voltage from power sources in underground vaults can be a serious and deadly problem. Additionally, during each subsequent visit to this underground structure a new receptacle must be installed for power access.

Accordingly, it is desirable to provide a mechanism to provide power underground that overcomes these and other drawbacks of the current devices and methods. In particular, it is desirable to provide a permanent electrical source for use in an underground vault that can inhibit and/or eliminate stray voltage in the event water or other liquids envelope the power source and/or vault.

### SUMMARY OF THE INVENTION

The present invention is directed towards a socket assembly for providing a power socket proximate a cable and/or cable joint, for example, at a location underground. The socket assembly preferably includes a hot lead connectable to the cable or cable joint to draw power therefrom, a ground lead and a neutral lead (or a single ground/neutral lead). The leads are connected to a socket to which a power plug can be connected. The socket and lead assembly is preferably potted to provide a water-tight seal. The assembly also preferably includes a cap for providing a water-tight seal over the exposed interface end of the socket. The socket assembly may also comprise an electronic shut off that turns off power to the socket after a pre-determined period of time. Another safety option would be to incorporate a GFI (Ground Fault Interrupter) to the socket assembly. The socket assembly of the present invention provides a fully submersible power source which does not have to be removed after each visit to the underground vault.

Other objects and features of the present invention will become apparent from the following detailed description, considered in conjunction with the accompanying drawing figure. It is to be understood, however, that the drawings are designed solely for the purpose of illustration and not as a definition of the limits of the invention, for which reference should be made to the appended claims.

### BRIEF DESCRIPTION OF THE DRAWINGS

The particular features and advantages of the invention as well as other objects will become apparent from the following description taken in connection with the accompanying drawings, in which:

FIG. 1 is a perspective view of a socket assembly, installed on a cable joint, in accordance with an embodiment of the invention;

FIG. 2 is a side view of a socket assembly in accordance with an embodiment of the invention, with a removable cap shown in a closed position;

FIG. 3 is a perspective view of the socket assembly of FIG. 2, with the removable cap shown in an open position;

FIG. 4 is a perspective view of a socket assembly with a removable cap having an open face;

FIG. 5 is a cross sectional view of the socket assembly of FIG. 2;

FIG. 6 is a perspective view of a socket and cable joint assembly in accordance with an embodiment of the invention.

FIG. 7 is a cross sectional view of a socket assembly with an integrally formed shut off device in accordance with an embodiment of the invention;

FIG. 8 is a cross sectional view of a socket assembly with a shut off device in accordance with an embodiment of the invention; and

FIG. 9 is a circuit schematic of the shut off device of FIGS. 7 and 8 in accordance with an embodiment of the invention.

### DESCRIPTION OF EXEMPLARY EMBODIMENTS

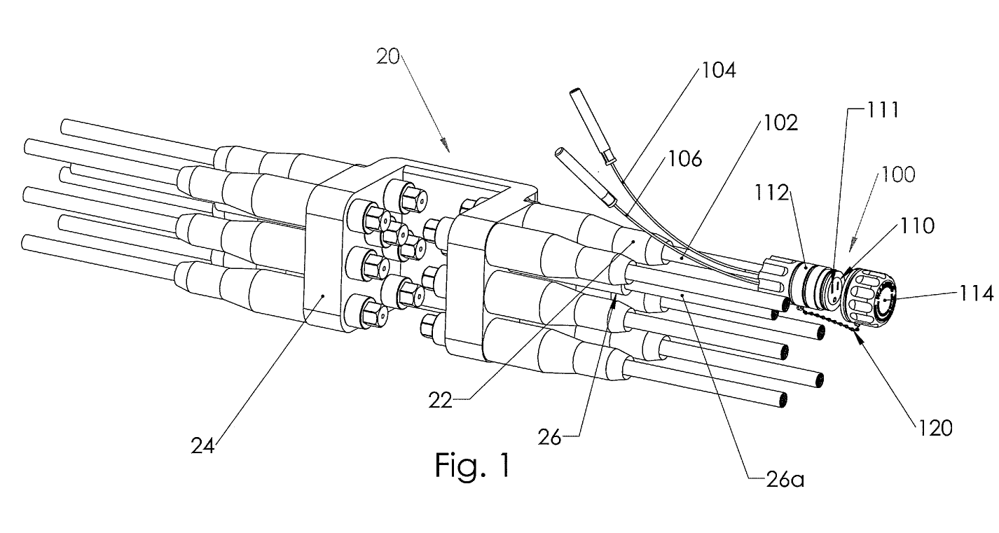

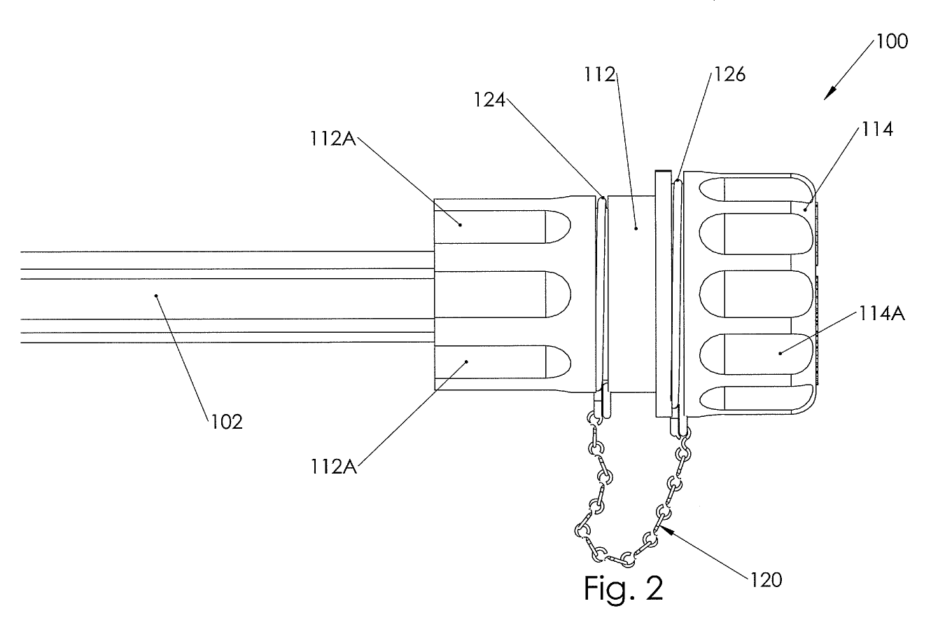

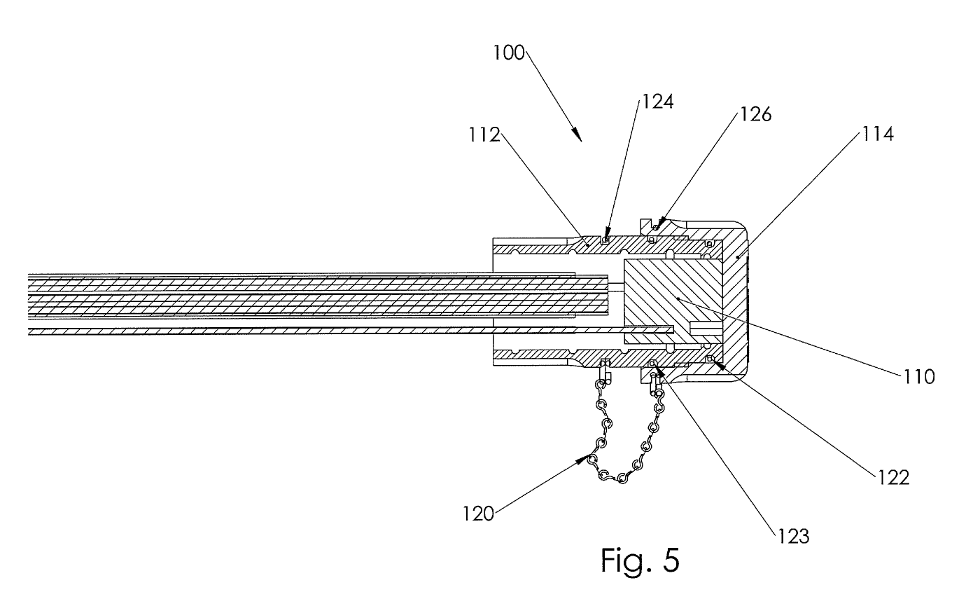

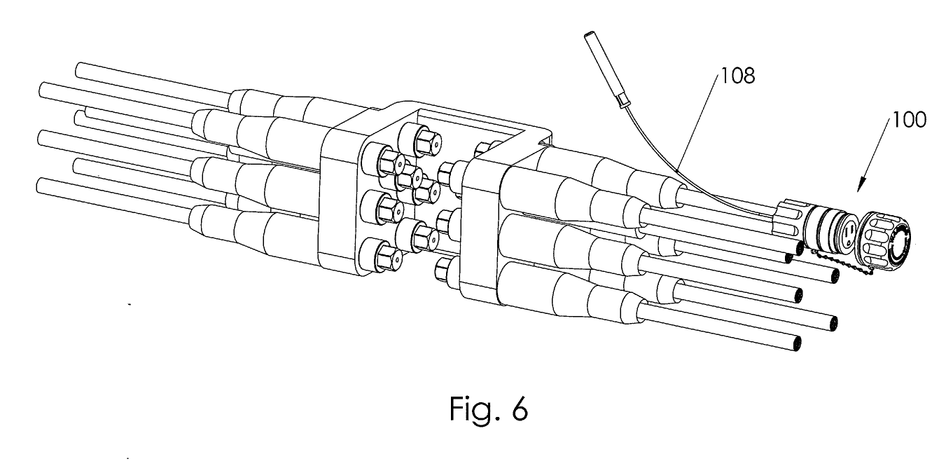

Certain exemplary embodiments of the present invention will now be described with reference to the drawings shown in FIGS. 1-9. In general, such embodiments relate to a socket assembly 100 that can be electrically and physically connected to a cable or cable joint 20. The cable or cable joint 20 can be connected to a power source and thus provide power, such as electric power, to the socket assembly 100. The socket assembly 100 of the present invention can be connected directly to a cable, and can also be connected to various types of cable joints. While FIGS. 1 and 6 depict a specific cable joint 20 for use with the socket assembly 100 of the present invention, the socket assembly 100 can be used with other types of cable joints such as, for example, crab joints, insulated crab joints and other joints that are known and used in the industry.

As shown in FIGS. 1-6, the socket assembly 100 can include a socket body 112 having a socket interface 110, the socket body 112 being connected to a hot lead 102. The socket assembly 100 may also include a ground lead 104 and a neutral lead 106 as seen in FIG. 1, or may include a single ground/neutral lead 108 as seen in FIG. 6. In a preferred embodiment, the hot lead 102 is larger than the other leads so that the socket assembly 100 can be rigid when installed. The connection between the leads and the socket body, and in particular between the hot lead 102 and socket body 112, is preferably potted to provide a water tight seal between the leads and in particular the hot lead 102 and the socket body 112. The socket interface 110 is preferably constructed and arranged to accept a power plug or other interface of a device, such as an electric device, to the socket body 112. For example, the socket interface 110 can include a plurality of apertures through which a plurality of prongs from the power plug can be inserted into the socket body 112. Once the power plug is connected to the socket body 112, electricity can flow between the electric device and the socket assembly 100, and more specifically, between the power source and the electric device through the cable or cable joint 20 and the socket assembly 100.

The hot lead 102 is preferably connected to the socket body 112 at a first end and can connect to the cable or cable joint 20 at a second end. The hot lead 102 can be electrically connected to the cable or cable joint in any number of ways. For example, when used with insulated crab joints, the hot lead 102 can be crimped to the cable joint and the connection can be insulated using the insulation of the crab joint. The connection could also be taped.

In accordance with an exemplary embodiment, by way of example as seen in FIGS. 1 and 6, the hot lead 102 can be connected to the cable joint 20 at a suitable connecting element, such as a leg 22 of the cable joint 20. For example, hot lead 102 can be inserted into a copper tube or other receiving element of leg 22, and the copper tube can be compressed onto hot lead 102. Once connected, electricity can preferably flow between the cable or cable joint 20 and the socket body 112 via hot lead 102.

The socket assembly 100 preferably includes a ground lead 104 and a neutral lead 106. The ground lead 104 is preferably constructed and arranged to connect to a grounding element, and the neutral lead 106 is preferably constructed and arranged to connect to a neutralizing element. The grounding element and the neutralizing element are preferably located proximate the cable joint 20.

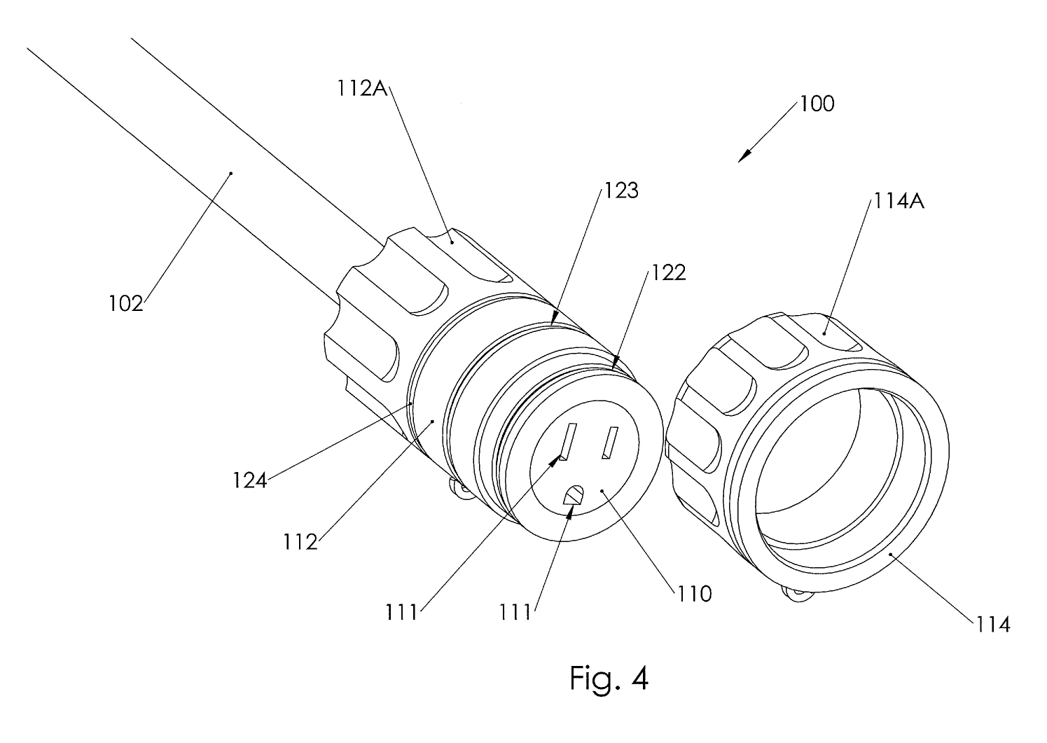

The socket assembly 100 is preferably insulated, for example, by a rubber casing. Preferably, as seen in FIGS. 1-8, the socket assembly 100 includes a cap 114 which is constructed and arranged to cover the socket interface 110 when the cap 114 is in the closed position. The cap 114 may be removable to expose the socket interface 110 so that the plug or other device can be connected to the socket assembly 100. In an alternative embodiment, as seen in FIG. 4, the cap 114 may have an open face for access to the interface 110 without having to remove the cap. In accordance with an exemplary embodiment, the cap 114 includes a cavity in which a portion of the socket body 112 including the socket interface 110 can be received.

The cap 114 can include a threaded inner wall and the body 112 can include a threaded outer wall such that the cap 114 can be screwed onto the body 112. Alternatively, the cap 114 can engage the body 112 via a friction fit or other mechanism without deviating from the scope of the invention. Preferably, the cap 114 includes grooves 114a, which may facilitate gripping the cap 114 to rotate it, slide it over the body 112, or otherwise manipulate the cap 114. The body 112 can also include one or more grooves 112a, which may facilitate gripping the body 112.

Preferably, when the cap 114 is in the closed position, the cap 114 creates a seal such that water and other materials cannot seep in between the body 112 and cap 114 thus protecting the socket interface 110. Therefore, the apertures 111 of the socket interface 110 can be protected from water and other debris when the cap is installed on the body.

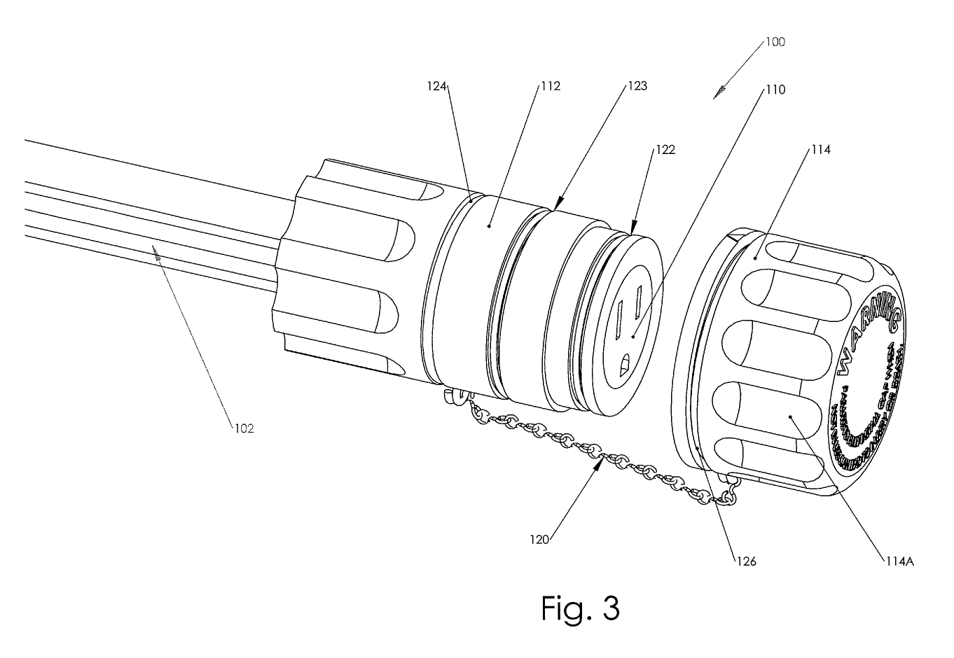

Referring to FIGS. 3-7, one or more sealing rings 122, 123, 124 can be provided on the outer periphery of the body 112. Preferably, the sealing rings are O-rings that can contact the inner wall of the cap 114 to create a seal between the body 112 and the cap 114. Preferably, the sealing rings 122, 123, 124 extend radially outward from the body 112. More specifically, the sealing rings 122, 123, 124 can have an outer diameter greater than the outer diameter of the body 112, to help seal the gap between the cap 114 and the body 112. In accordance with a preferred embodiment, sealing rings 122, 123, 124 can be formed of rubber or other material that can be deformed, contracted, or otherwise adjusted to permit the cap 114 to be positioned over the sealing rings 122, 123, 124 while maintaining a sealing contact between the sealing rings 122, 123, 124 and the cap 114.

Referring to FIGS. 1-8, a chain 120 can connect the cap 114 to the body 112, so that when the cap 114 is removed from the body 112, the cap 114 is not separated from the body 112 and does not get lost. Preferably, the chain 120 is connected to the body 112 via a first O-ring 124 and to the cap 114 via a second O-ring 126. An O-ring may be more resilient, facilitate manufacture, or provide other benefits compared to attaching the chain 120 directly onto the body 112 or the cap 114. Other means of connecting the chain 120 to the body and the cap are envisioned without departing from the scope of the invention. For example, another preferred alternative is a rigid ring that will not easily separate from the cap or the body. It is to be also understood that other mechanisms for connecting the cap 114 to the body 112, such as a strap, elastic, etc. can be provided instead of or in combination with the chain 120 without deviating from the scope of the invention.

Referring to FIG. 6, in accordance with an embodiment, the socket assembly 100 can include a single neutral-and-ground lead 108, instead of separate ground lead 104 and neutral lead 106. The neutral-and-ground lead 108 can be connected to a ground element, a neutral element, or a neutral-and-ground element.

By way of non-limiting example, as seen in FIGS. 1 and 6, an embodiment of the cable joint 20 can include a U-shaped base 24 connected to the plurality of legs 22, wherein each leg 22 is constructed to receive a cable. In the embodiment illustrated, cable joint 20 has six legs 22 on each side of base 24. Legs 22 can be connected via compression connections to base 24. Preferably, each side of base 24 also includes at least one non-fused connector 26 having a cable 26a to create a “ring” bus for the purpose of balancing the electric load on more than one crab joint of the same phase. Cable 26a can be connected to another cable 26a of a nearby cable joint of the same phase (A,B,C) thereby creating the “ring bus” (i.e., an electrical reference point). An example of a cable joint 20 is provided in copending U.S. patent application Ser. No. 12/207,267, the contents of which are incorporated in its entirety by reference herein.

Alternatively, hot lead 102 can be connected to a different device or mechanism, for example a cable or insulated crab joint, from which power can be provided to the device connected to the socket interface 110 without deviating from the scope of the invention. Furthermore, whereas the cable joint 20 has been described herein as being connected to one or more legs 22, it is to be understood that other variations are contemplated as a matter of application specific design choice. By way of non-limiting example, cable or base 24 may be connected directly to hot lead 102 or via a connector or other device without deviating from the scope of the invention.

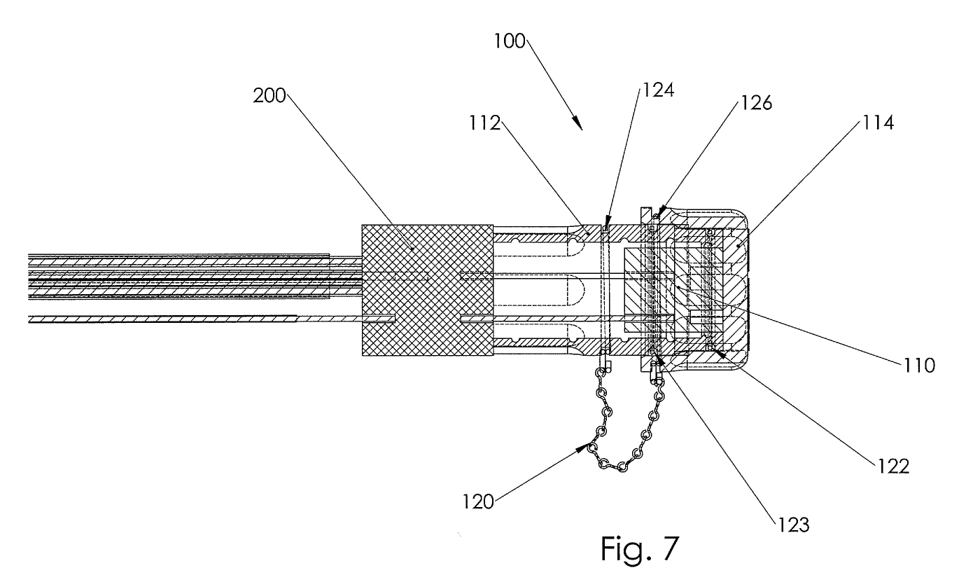

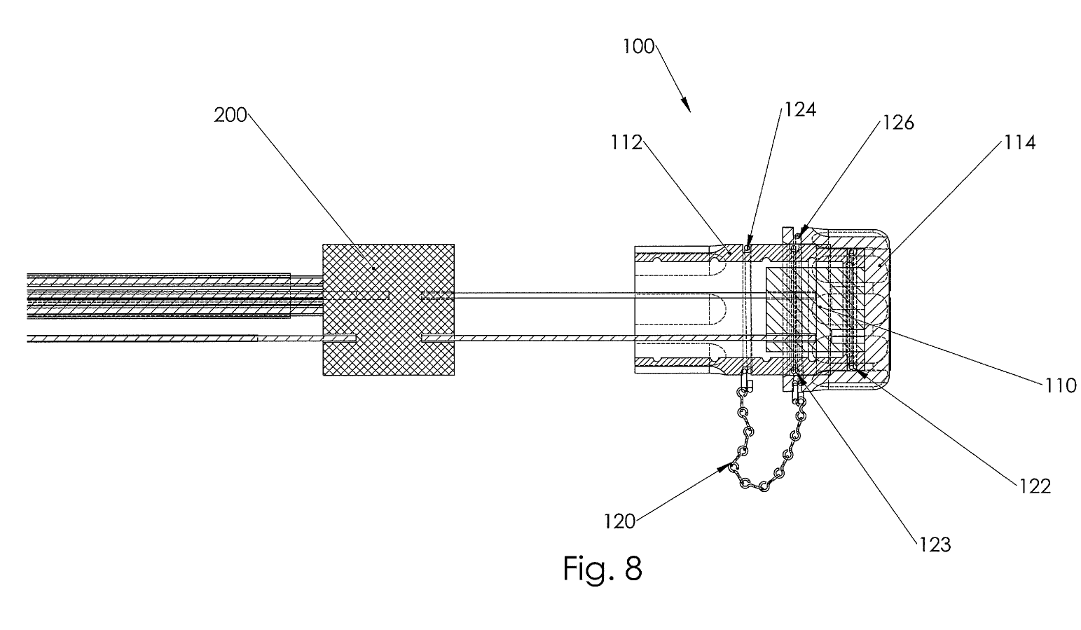

As seen in FIGS. 7-9, the socket assembly 100 may also include a shut off device 200 that can turn off power to the socket interface 110 or a GFI that can interrupt power to the receptacle if more current is sensed in the hot lead as opposed to the ground and/or neutral leads. In a preferred embodiment, the shut off device is designed to automatically turn off power to the socket interface after a predetermined period of time. The shut off device 200 (or GFI device) can be formed integrally with the socket body 112 as seen in FIG. 7, or may be formed as a separate element along hot lead 102 as seen in FIG. 8. In either embodiment, the interface between hot lead 102 and shut off device 200 is potted to provide a water tight seal.

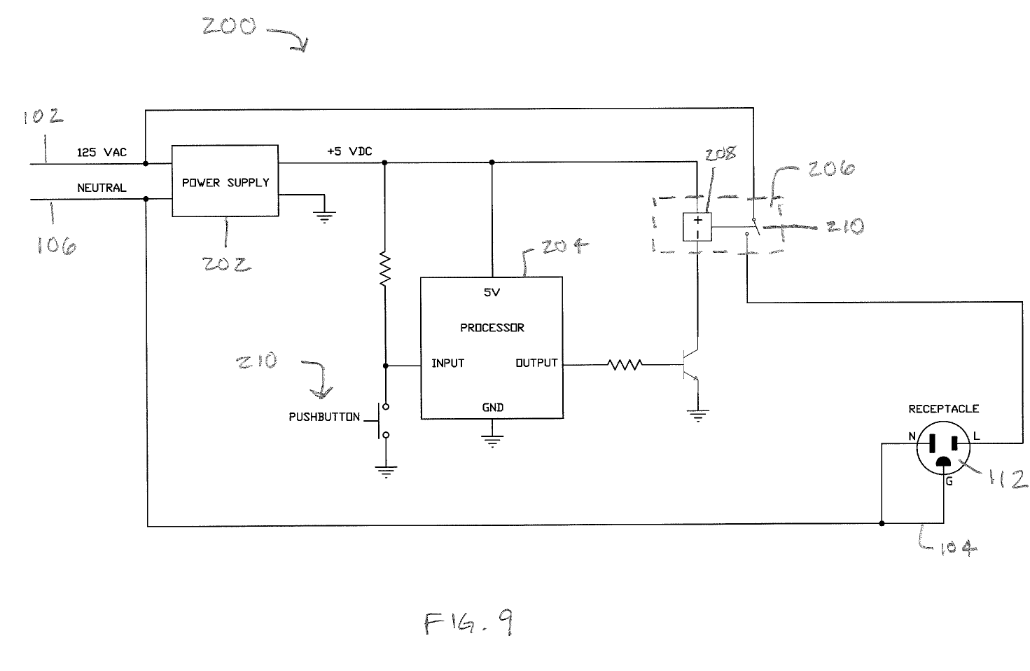

In a preferred embodiment as seen in FIG. 9, shut off device 200 includes a power supply 202, a processor 204, and a contactor 206. When the shut off device is engaged, for example by engaging a sealed pushbutton 210, the processor 204 turns on the contactor 206 to provide power to socket body 112. In a preferred embodiment, after a predetermined period of time the processor can turn off the contactor 206 to prevent power to socket body 112. In a preferred embodiment, the contactor 206 includes a switch 210 controlled by an actuator 208. In a preferred embodiment, the power supply 202 is electrically connected to the hot lead 102 and neutral lead 106, and the hot lead 102 is also connected to one side of switch 210. The power supply 202 powers the processor 204, which powers the actuator 202 for actuating the switch 210 to complete or disconnect the power based on a predetermined period of time. The shut off device 200 provides an additional and important safeguard against stray voltage that can be caused by water buildup around the cable and/or joint by turning off power to the socket body after a period of time, thus ensuring a safe and properly insulated voltage source.

The examples provided are merely exemplary, as a matter of application specific to design choice, and should not be construed to limit the scope of the invention in any way. Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. For example, the type of cable and/or cable joint, the number of socket interfaces provided for each socket cable, the number of socket assemblies connected to a cable joint, the number of socket cables connected to a socket interface, the type of cap for covering the socket interface, the shape of the cable joint, the number of legs or ring buses provided thereon, sides to the base, etc. can be varied without deviating from the scope of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

I claim:

1. A socket assembly for use with a cable joint, the socket assembly comprising:
a body having an interface for connecting to an electric device and a removable cap adapted to sealingly cover the socket interface when in a closed position;
a first lead connected to the interface at one end, sealingly exiting the body and adapted to be connected to a power source on the cable joint at the other end;
a second lead connected to the interface at one end and adapted to be connected to a ground element at the other end; and
a third lead connected to the interface at one end and adapted to be connected to a neutral element at the other end.

2. The socket assembly of claim 1, wherein the body includes a threaded outer wall and wherein the removable cap includes a threaded inner wall such that the removable cap can be threaded onto the body.

3. The socket assembly of claim 1, wherein the outer periphery of the body includes one or more sealing rings to engage the inner periphery of the removable cap to seal the socket interface.

4. The socket assembly of claim 1, wherein the first lead is larger than the second and third leads.

5. The socket assembly of claim 1, wherein the body is potted.

6. The socket assembly of claim 1, further comprising a Ground Fault Interrupter arranged to interrupt power to the interface.

7. A socket assembly for use with a cable joint, the socket assembly comprising:
a hot lead adapted to be electrically connected to the cable joint at one end, a neutral lead adapted at one end to be connected to a neutral element,
a shut off device, a body having an interface for connecting to an electric device, and a removable cap adapted to sealingly cover the interface when in a closed position;
the shut off device comprising a power supply, a processor and a contactor;
the hot lead electrically connected to the power supply and electrically connected to the interface through the contactor, the neutral lead electrically connected to the power supply and the interface;
the power supply providing electrical power to the processor for controlling the contactor to provide power to the interface for a predetermined period of time.

8. The socket assembly of claim 7, wherein the shut off device further comprises a pushbutton for engaging the processor.

9. The socket assembly of claim 7, wherein the contactor comprises an actuator and a switch.

10. The socket assembly of claim 7, wherein the shut off device is integrally formed with the body.

11. The socket assembly of claim 7, wherein the shut off device is not integrally formed with the body.

12. The socket assembly of claim 7, wherein the body includes a threaded outer wall and wherein the removable cap includes a threaded inner wall such that the removable cap can be threaded onto the body.

13. The socket assembly of claim 7, wherein the outer periphery of the body includes one or more sealing rings to engage the inner periphery of the removable cap to seal the socket interface.

14. The socket assembly of claim 7, wherein the hot lead is larger than the neutral lead.

15. The socket assembly of claim 7, wherein the body is potted.

16. A socket assembly for use with a cable joint having multiple legs, the legs connected to the cable joint at one end and having a connecting element at the other end constructed and designed to accept and electrically connect a cable to the leg, the socket assembly comprising:
a body having an interface for connecting to an electric device;
a power cable connected to the interface at one end and constructed and arranged to be connected to a connecting element on the cable joint at the other end;
a ground lead connected to the interface; and
a neutral lead connected to the interface.

17. The socket assembly of claim 16, wherein the connecting element is a copper tube and wherein the power cable is designed and constructed to be compressed within the copper tube.

18. The socket assembly of claim 16, further comprising a removable cap constructed and arranged to cover the socket interface when in a closed position.

19. The socket assembly of claim 17, wherein the body includes a threaded outer wall and wherein the removable cap includes a threaded inner wall such that the removable cap can be threaded onto the body.

20. The socket assembly of claim 16, wherein the outer periphery of the body includes one or more sealing rings to mate with the inner periphery of the removable cap to seal the socket interface.
